(19) United States
(12) Patent Application Publication
(10) Pub. No.: US 2026/0310986 A1
(43) Pub. Date: Oct. 8, 2026

(54) SPLIT FEDERATED LEARNING SYSTEM AND METHOD OPTIMIZED FOR VARIOUS HARDWARE ENVIRONMENTS AND LOCAL CLIENT FOR PERFORMING THE SAME

(71) Applicant: FOUNDATION OF SOONGSIL UNIVERSITY-INDUSTRY COOPERATION, Seoul (KR)

(72) Inventors: MINHAE KWON, Seoul (KR); MIRU KIM, Seoul (KR); HEEWON PARK, Seoul (KR)

(21) Appl. No.: 19/267,897

(22) Filed: Jul. 14, 2025

(30) Foreign Application Priority Data
Apr. 8, 2025 (KR) 10-2025-0045651

(51) Int. Cl. G06N 3/098; G06N 3/045

(52) U.S. Cl. CPC G06N 3/098; G06N 3/045

(57) ABSTRACT

A split federated learning system includes a plurality of local clients and a server, in which each of the plurality of local clients includes a local model, the server includes a global model, the local model includes a personalized neural network and a federated neural network, the personalized neural network is provided with one or more of a size and structure of a neural network differently depending on performance of each local client, and the federated neural network is provided with the same size and structure of the neural network in each local client.

### CROSS-REFERENCE TO RELATED APPLICATION AND CLAIM OF PRIORITY

This application claims the benefit under 35 USC § 119 (a) of Korean Patent Application No. 10-2025-0045651 filed on Apr. 8, 2025, in the Korean Intellectual Property Office, the entire disclosure of which is incorporated herein by reference for all purposes.

### BACKGROUND

### 1. Field

Embodiments of the present disclosure relate to a split federated learning technique.

### 2. Description of Related Art

In federated learning, individual devices (i.e., local clients) may train a neural network model without exposing data collected by the individual devices by transmitting only parameters of their local models to a server and sharing the parameters, instead of directly transmitting raw data, thereby preventing the risk of exposing private information.

However, since local clients with limited computational capability and processing capability cannot train or store large-scale neural network models, the capacity and performance of neural network models are limited by the hardware capacity of the local client. Accordingly, split federated learning technology, in which a plurality of local clients and a central server collaboratively train a neural network model, is attracting attention.

However, the existing split federated learning is designed so that all local clients share a neural network model of the same size and structure, which poses the following problems. 1) As all local clients use the neural network model of the same size and structure, high-spec local clients cannot fully utilize their computational capabilities, and low-spec local clients have limitations in computational processing, making it difficult to optimize the performance of the neural network model, which results in a risk of reduced learning efficiency. 2) Since the local clients and the server share the neural network model, the local client should acquire assistance from the server during an inference process. However, when the server cannot be used due to a communication failure, the local client cannot perform independent inference.

Examples of related art may include Korean Unexamined Patent Application Publication No. 10-2025-0025891 (2025 Feb. 25).

### SUMMARY

Embodiments of the present disclosure are intended to provide a split federated learning system and method optimized for various hardware environments and a local client for performing the same.

A system according to a disclosed embodiment is a split federated learning system including a plurality of local clients and a server, in which each of the plurality of local clients includes a local model, the server includes a global model, the local model includes a personalized neural network and a federated neural network, the personalized neural network is provided with one or more of a size and structure of a neural network differently depending on performance of each local client, the federated neural network is provided with the same size and structure of the neural network in each local client.

An output from an output layer of the personalized neural network may be provided to be input to an input layer of the federated neural network.

The number of parameters configuring the personalized neural network may be set based on the number of times of floating point operations per second of a corresponding local client and processing time required for the local model.

The number of parameters P configuring the personalized neural network may be set by Equation below.

$$P = \frac{F L O P {S}_{device} \cdot T}{F L O P {S}_{parameter}} \qquad Equation$$

FLOPSₚₐᵣₐₘₑₜₑᵣ: floating point operation per second (FLOPS) per individual parameter
FLOPS_{device}: FLOPS of corresponding local client
T: processing time required for local model

The split federated learning may include a split learning process and a federated learning process, in the split learning process, the local client may input local data into the personalized neural network and transmit an output of the personalized neural network to the server, the server may input the output of the personalized neural network into the global model to train the global model, and transmit a gradient acquired in a training process of the global model to the local client, and the local client may input the gradient received from the server into the personalized neural network to update a parameter of the personalized neural network.

In the federated learning process, the local client may update a parameter of the personalized neural network and a parameter of the federated neural network through local data, respectively, and transmit the updated parameter of the federated neural network to the server, the server may aggregate the parameter of the federated neural network received from each local client to generate a federated global parameter, and transmit the generated federated global parameter to each local client, and the local client may update the parameter of the federated neural network with the federated global parameter received from the server.

The local client may acquire an inference result through the global model of the server or acquire an inference result through the local model depending on whether a network communication state of the local client is stable when an inference event occurs after training of the local model is completed.

The local client may determine whether the network communication state is stable by comparing a data transmission amount per unit time of the local client and a data size of an output of the personalized neural network, and the output of the personalized neural network may be an output from the personalized neural network by inputting inference target data into the personalized neural network.

A method according to a disclosed embodiment is a method for split federated learning performed on each local client of a system including a plurality of local clients each including a local model and a server including a global model, the local model including a personalized neural network and a federated neural network, and the federated neural network being provided with the same size and structure of the neural network in each local client, and the method includes setting the number of parameters configuring the personalized neural network according to performance of the local client, performing a split learning process for parameter update of the personalized neural network and performing a federated learning process for parameter update of the federated neural network.

In the setting of the number of parameters configuring the personalized neural network, the number of parameters configuring the personalized neural network may be set based on the number of times of floating point operations per second of the local client and processing time required for the local model.

The performing of the split learning process may include inputting local data into the personalized neural network and transmitting an output of the personalized neural network to the server, receiving a gradient acquired in a training process of the global model from the server; and inputting the received gradient into the personalized neural network to update a parameter of the personalized neural network.

The performing of the federated learning process may include updating the parameter of the personalized neural network and a parameter of the federated neural network, respectively, through local data, and transmitting the updated parameter of the federated neural network to the server, receiving a federated global parameter generated by aggregating the parameter of the federated neural network of each local client from the server, and updating the parameter of the federated neural network with the received federated global parameter.

The method may further include checking whether an inference event occurs after training of the local model is completed, determining whether a network communication state of the local client is stable when the inference event occurs, inputting inference target data into the personalized neural network and transmitting an output of the personalized neural network to the server when the network communication state is stable, and receiving an inference result for the inference target data from the global model of the server.

In the determining of whether the network communication state is stable, whether the network communication state is stable may be determined by comparing a data transmission amount per unit time of the local client and a data size of an output of the personalized neural network.

The method may further include inputting the output of the personalized neural network into the federated neural network to acquire an inference result for the inference target data when the network communication state is not stable.

A local client according to a disclosed embodiment is a local client of a split federated learning system including a plurality of local clients each including a local model and a server including a global model, in which the local model includes a personalized neural network and a federated neural network, the federated neural network is provided with the same size and structure of the neural network in each local client, the local client includes a memory in which one or more programs stored, and the one or more programs include an instruction for setting the number of parameters configuring the personalized neural network according to performance of the local client, an instruction for performing a split learning process for parameter update of the personalized neural network, and an instruction for performing a federated learning process for parameter update of the federated neural network.

### BRIEF DESCRIPTION OF THE DRAWINGS

FIG. 1 is a diagram showing a configuration of a split federated learning system according to an embodiment of the present disclosure.

FIG. 2 is a diagram schematically showing a local model according to an embodiment of the present disclosure.

FIGS. 3A and 3B are diagrams schematically showing a state in which a personalized neural network is set differently depending on the performance of a local client according to an embodiment of the present disclosure.

FIG. 4 is a flowchart showing a split learning process in split federated learning according to an embodiment of the present disclosure.

FIG. 5 is a flowchart showing a federated learning process in split federated learning according to an embodiment of the present disclosure.

FIG. 6 is a flowchart showing an inference process after training of a local model is completed according to an embodiment of the present disclosure.

FIG. 7 is a block diagram for illustratively describing a computing environment including a computing device suitable for use in exemplary embodiments.

### DETAILED DESCRIPTION

Hereinafter, specific embodiments of the present disclosure will be described with reference to the drawings. The following detailed description is provided to facilitate a comprehensive understanding of the methods, apparatuses, and/or systems described herein. However, this is only an example and the present disclosure is not limited thereto.

In describing embodiments of the present disclosure, if it is determined that a specific description of a related known function of the preset invention may unnecessarily obscure the gist of the present disclosure, the detailed description thereof will be omitted. The terms described below are terms defined in consideration of the functions in the present disclosure, and vary depending on the intention or custom of the user or operator. Therefore, the definition should be made based on the contents throughout this specification. The terminology used in the detailed description is for the purpose of describing embodiments of the present disclosure only and should not be construed as limiting. Unless expressly used otherwise, singular forms include plural forms. In this description, the terms “including” or “comprising” are intended to refer to certain features, numbers, steps, operations, elements, portions or combinations thereof, and should not be construed to exclude the presence or possibility of one or more other features, numbers, steps, operations, elements, portions or combinations thereof other than those described.

In addition, the terms first, second, etc. may be used to describe various components, but the components should not be limited by the terms. The terms may be used for the purpose of distinguishing one component from another component. For example, without departing from the scope of the present disclosure, a first component may be referred to as a second component, and similarly, a second component may also be referred to as a first component.

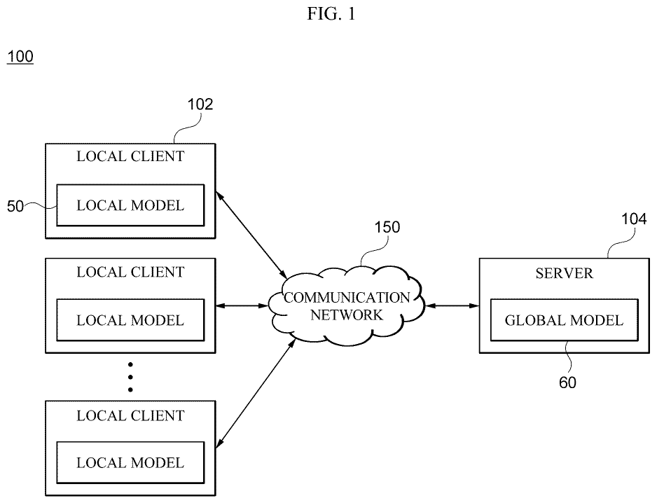

FIG. 1 is a diagram showing a configuration of a split federated learning system according to an embodiment of the present disclosure.

Referring to FIG. 1, a split federated learning system 100 may include a plurality of local clients 102 and a server 104. Each of the plurality of local clients 102 is communicatively connected to the server 104 through a communication network 150.

In an embodiment, the communication network 150 may include the Internet, one or more local area networks, wide area networks, cellular networks, mobile networks, other types of networks, or a combination of these networks.

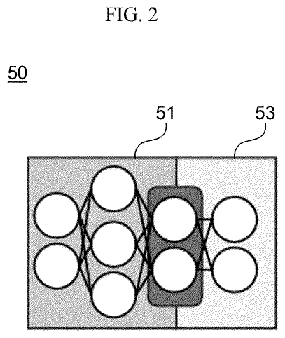

Each local client 102 includes an artificial intelligence-based local model. Here, the local model may include a personalized neural network and a federated neural network. FIG. 2 is a schematic diagram of a local model in an embodiment of the present disclosure. Referring to FIG. 2, a local model 50 may include a personalized neural network 51 and a federated neural network 53.

The personalized neural network 51 may be a neural network portion that is individually set according to the performance of each local client 102. Accordingly, the personalized neural network 51 for each local client 102 may have a different size, structure, etc. of a neural network. For example, the personalized neural network 51 of each local client 102 may have different numbers of layers and parameters depending on the performance (e.g., the GPU, the memory, computational capability, etc.) of the local client 102.

The federated neural network 53 may be a neural network portion that is provided for federated learning in each local client 102. The federated neural network 53 may be a neural network portion configured with the same structure and size in each local client 102.

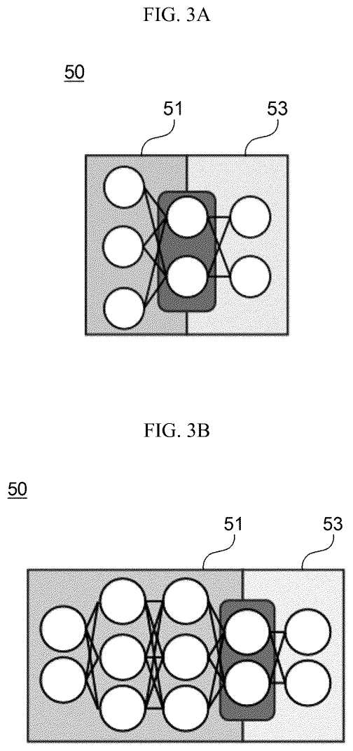

Here, an output from an output layer of the personalized neural network 51 may be provided to be input to an input layer of the federated neural network 53. In an embodiment, the output layer of the personalized neural network 51 and the input layer of the federated neural network 53 may be provided by being connected. Alternatively, the output layer of the personalized neural network 51 and the input layer of the federated neural network 53 may be shared. In FIGS. 2 to 3B, the output layer of the personalized neural network 51 and the input layer of the federated neural network 53 are illustrated as being shared.

Meanwhile, the number of parameters configuring the personalized neural network 51 may be set based on the number of times of floating point operations per second (FLOPS) of the local client 102 and the processing time required for the local model. In an embodiment, the number of parameters P configuring the personalized neural network 51 may be set by Equation 1 below.

$$P = \frac{F L O P {S}_{device} \cdot T}{F L O P {S}_{parameter}} \qquad Equation 1$$

FLOPSₚₐᵣₐₘₑₜₑᵣ: FLOPS per individual parameter
FLOPS_{device}: FLOPS of corresponding local client
T: processing time required for local model

FIGS. 3A and 3B are diagrams schematically showing a state in which the personalized neural network is set differently depending on the performance of the local client 102 in an embodiment of the present disclosure. In FIG. 3A, the case in which the performance of the local client 102 is low and thus the size of the personalized neural network 51 is small is shown, and in FIG. 3B, the case in which the performance of the local client 102 is high and thus the size of the personalized neural network 51 is large is shown.

The server 104 may perform split federated learning with a plurality of local clients 102. Here, the split federated learning may be divided into a split learning process and a federated learning process. The server 104 includes an artificial intelligence-based global model 60. The global model 60 may be a large-scale model having a larger neural network size than the local model 50.

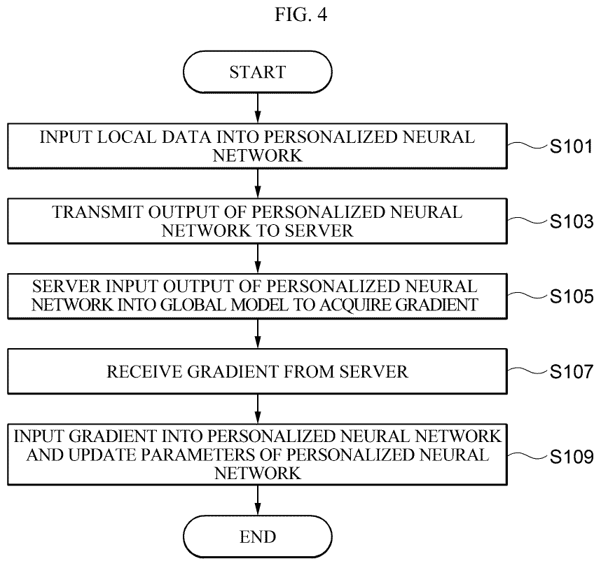

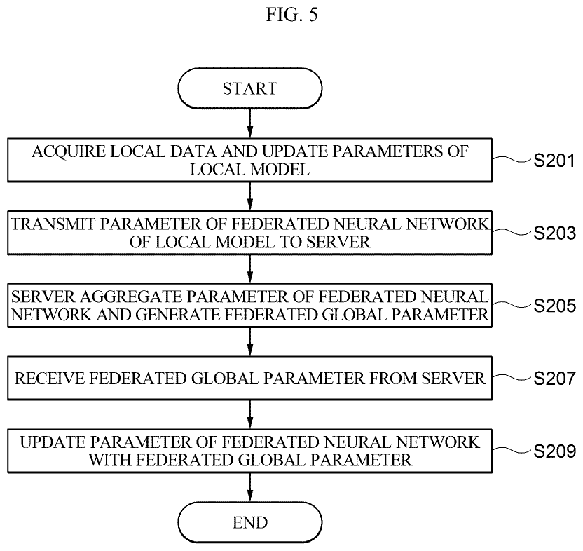

The server 104 may train the global model 60 through the split learning process. In this case, each local client 102 may update a parameter of the personalized neural network 51 through the split learning process. The server 104 may generate a federated global parameter in the federated learning process and transmit the federated global parameter to each local client 102. Each local client 102 may update a parameter of the federated neural network 53 through the federated learning process. Hereinafter, the split learning process and the federated learning process will be described with reference to FIGS. 4 and 5, respectively.

FIG. 4 is a flowchart illustrating a split learning process during the split federation learning according to an embodiment of the present invention. In the illustrated flowchart, the method may be described by being divided into a plurality of steps, but at least some of the steps may be performed in a different order, combined with other steps and performed together, omitted, divided into sub-steps and performed by adding one or more steps (not shown).

Referring to FIG. 4, the local client 102 may acquire local data for split learning and input the local data into the personalized neural network 51 (S 101). The local client 102 may transmit an output of the personalized neural network 51 to the server 104 (S 103).

The server 104 may input the output of the personalized neural network 51 into the global model 60 to train the global model 60 (S 105). Specifically, the server 104 may calculate a loss value required to train the global model 60 based on ae difference between an output from the global model 60 and a correct answer value, and may update the parameter of the global model 60 by back-propagating the loss value. In this case, the server 104 may acquire a gradient (i.e., a value used to update the parameters of the corresponding layer) for each layer of the global model in the backpropagation process.

The server 104 may transmit the gradient acquired from the input layer (first layer) of the global model 60 during the backpropagation process to the local client 102 (S 107). The local client 102 may input the gradient received from the server 104 into the personalized neural network 51 and update the parameter of the personalized neural network 51 through the backpropagation method (S 109).

That is, in the split learning process, the output of the personalized neural network 51 of the local client 102 is used as an input of the global model of the server 104 to train the global model, and the gradient generated in the training process of the global model is input to the personalized neural network 51 to update the parameter of the personalized neural network 51. In this way, only the personalized neural network 51 portion of the local model 50 can be updated in the split learning process. Through the split learning process, each local client 102 optimizes the personalized neural network 51 implemented according to the performance of the local client 102.

FIG. 5 is a flowchart showing the federated learning process of the split federated learning according to an embodiment of the present disclosure. In the illustrated flowchart, the method may be described by being divided into a plurality of steps, but at least some of the steps may be performed in a different order, combined with other steps and performed together, omitted, divided into sub-steps and performed by adding one or more steps (not shown).

Referring to FIG. 5, the local client 102 may acquire local data for federated learning and update the parameter of the local model 50 (S 201).

Specifically, the local client 102 may input the acquired local data into the personalized neural network 51 and input an output of the personalized neural network 51 into the federated neural network 53. The local client 102 may calculate a loss value based on a difference between the output of the federated neural network 53 and a correct answer value and back-propagate the loss value to update the parameter of the federated neural network 53 and the parameter of the personalized neural network 51, respectively.

The local client 102 may transmit the parameter (i.e., the updated parameters) of the federated neural network 53 of the local model 50 to the server 104 (S 203).

The server 104 may aggregate the parameters of the federated neural network 53 received from the respective local clients 102 and generate a federated global parameter based on the aggregated parameters of each federated neural network 53 (S 205).

In an embodiment, the server 104 may generate a federated global parameter by calculating an average of the aggregated parameters of the respective federated neural networks 53. The federated global parameter W may be calculated by Equation 2 below.

$$\overline{W} = \frac{1}{N} {\sum }_{i = 1}^{N} {W}_{i} \qquad Equation 2$$

N: Total number of local clients
Wᵢ: parameter of federated neural network of i-th local client

The server 104 may transmit the federated global parameter to each local client 102 (S 207). Each local client 102 may update the parameter of the federated neural network 53 with the federated global parameter received from the server 104 (S 209).

In this way, each local client 102 trains the personalized neural network 51 through the split learning process and trains the federated neural network 53 through the federated learning process.

According to the disclosed embodiment, by dividing the local model 50 provided in each local client 102 into the personalized neural network 51 and the federated neural network 53, it is possible to optimize the personalized neural network 51 of each local client 102 according to the performance of each local client 102.

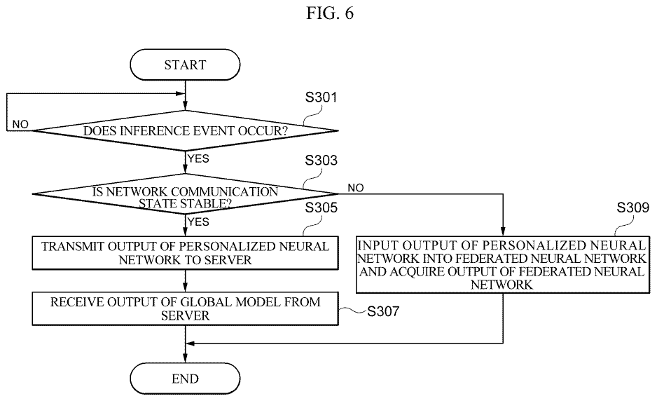

FIG. 6 is a flowchart showing an inference process after training of the local model is completed in an embodiment of the present disclosure. In the illustrated flowchart, the method may be described by being divided into a plurality of steps, but at least some of the steps may be performed in a different order, combined with other steps and performed together, omitted, divided into sub-steps and performed by adding one or more steps (not shown).

Referring to FIG. 6, the local client 102 may check whether an inference event occurs (S 301). That is, the local client 102 may check whether the inference event occurs in a state in which the training of the local model 50 is completed. In an embodiment, the inference event may occur upon the acquisition of inference target data.

Next, the local client 102 may determine whether a network communication state of the local client 102 is stable (S 303).

In an embodiment, the local client 102 may determine whether the network communication state is stable by comparing a data transmission amount per unit time of the local client 102 and a data size of an output of the personalized neural network 51. Here, the data size of the output of the personalized neural network 51 means the data size of the output from the personalized neural network 51 when inference target data is input to the personalized neural network 51.

The local client 102 may determine that the network communication state is stable when an amount of data transmitted per unit time is greater than or equal to the data size of the output of the personalized neural network 51. The local client 102 may determine that the network communication state is not stable when the amount of data transmitted per unit time is less than the data size of the output of the personalized neural network 51.

As a result of the determination in step S 303, when the network communication state is stable, the local client 102 may transmit the output of the personalized neural network 51 to the server 104 (S 305). Then, the server 104 inputs the output of the personalized neural network 51 into the global model 60 to generate an output. The local client 102 may receive the output of the global model 60 from the server 104 (S 307).

That is, when the network communication state is stable, the local client 102 receives an inference result through the global model 60 of the server 104 to produce a more precise inference result.

As a result of the determination in step S 303, when the network communication state is not stable, the local client 102 may input the output of the personalized neural network 51 into the federated neural network 53 and acquire an output from the federated neural network 53 (S 309).

That is, when the network communication state is not stable, the local client 102 independently performs inference through the local model 50 to produce the inference result.

According to the disclosed embodiment, by inferring using the global model of the server 104 or inferring using the local model of the local client 102 depending on the network communication state of the local client 102, it is possible to produce an inference result even when the network communication state is not stable).

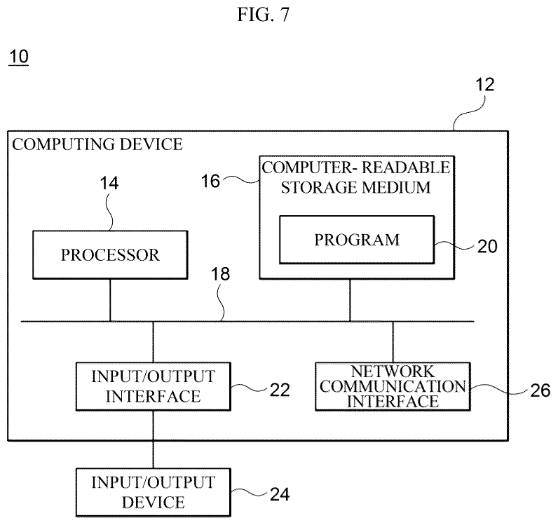

FIG. 7 is a block diagram illustrating a computing environment 10 including a computing device suitable for use in exemplary embodiments. In the illustrated embodiment, respective components may have different functions and capabilities other than those described below, and include additional components in addition to those described below.

The illustrated computing environment 10 includes a computing device 12. In an embodiment, the computing device 12 may be a local client 102. In addition, the computing device 12 may be a server 104.

The computing device 12 includes at least one processor 14, a computer-readable storage medium 16, and a communication bus 18. The processor 14 may cause the computing device 12 to operate according to the exemplary embodiment described above. For example, the processor 14 may execute one or more programs stored on the computer-readable storage medium 16. The one or more programs may include one or more computer-executable instructions, which, when executed by the processor 14, may be configured so that the computing device 12 performs operations according to the exemplary embodiment.

The computer-readable storage medium 16 is configured to store the computer-executable instruction or program code, program data, and/or other suitable forms of information. A program 20 stored in the computer-readable storage medium 16 includes a set of instructions executable by the processor 14. In an embodiment, the computer-readable storage medium 16 may be a memory (volatile memory such as a random access memory, non-volatile memory, or any suitable combination thereof), one or more magnetic disk storage devices, optical disk storage devices, flash memory devices, other types of storage media that are accessible by the computing device 12 and capable of storing desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 through the input/output interface 22. The exemplary input/output device 24 may include a pointing device (such as a mouse or trackpad), a keyboard, a touch input device (such as a touch pad or touch screen), a speech or sound input device, input devices such as various types of sensor devices and/or photographing devices, and/or output devices such as a display device, a printer, a speaker, and/or a network card. The exemplary input/output device 24 may be included inside the computing device 12 as a component configuring the computing device 12, or may be connected to the computing device 12 as a separate device distinct from the computing device 12.

According to the disclosed embodiment, by dividing the local model provided in each local client into the personalized neural network and the federated neural network, it is possible to optimize each personalized neural network of each local client according to performance of each local client.

In addition, by inferring using the global model of the server or inferring using the local model of the local client depending on the network communication state of the local client during inference, it is possible to produce an inference result even when the network communication state is not stable.

Although representative embodiments of the present disclosure have been described in detail above, those skilled in the art will understand that various modifications may be made to the above-described embodiments without departing from the scope of the present disclosure. Therefore, the scope of the present disclosure should not be limited to the described embodiments, but should be defined not only by the patent claims described below but also by those equivalent to the patent claims.

What is claimed is:

1. A split federated learning system comprising:
a plurality of local clients; and
a server,
wherein each of the plurality of local clients includes a local model,
the server includes a global model,
the local model includes a personalized neural network and a federated neural network,
the personalized neural network is provided with one or more of a size and structure of a neural network differently depending on performance of each local client, and
the federated neural network is provided with the same size and structure of the neural network in each local client.

2. The split federated learning system of claim 1, wherein an output from an output layer of the personalized neural network is provided to be input to an input layer of the federated neural network.

3. The split federated learning system of claim 1, wherein the number of parameters configuring the personalized neural network is set based on the number of times of floating point operations per second of a corresponding local client and processing time required for the local model.

4. The split federated learning system of claim 1, wherein the number of parameters P configuring the personalized neural network is set by Equation below,
$$P = \frac{F L O P {S}_{device} \cdot T}{F L O P {S}_{parameter}} \qquad [ Equation ]$$
wherein FLOPSₚₐᵣₐₘₑₜₑᵣ is floating point operation per second (FLOPS) per individual parameter,
FLOPS_{device} is floating point operation per second (FLOPS) of corresponding local client
T is processing time required for local model.

5. The split federated learning system of claim 1, wherein the split federated learning includes a split learning process and a federated learning process, and
in the split learning process,
the local client inputs local data into the personalized neural network and transmit an output of the personalized neural network to the server,
the server inputs the output of the personalized neural network into the global model to train the global model, and transmits a gradient acquired in a training process of the global model to the local client, and
the local client inputs the gradient received from the server into the personalized neural network to update a parameter of the personalized neural network.

6. The split federated learning system of claim 5, wherein, in the federated learning process,
the local client updates a parameter of the personalized neural network and a parameter of the federated neural network through local data, respectively, and transmits the updated parameter of the federated neural network to the server,
the server aggregates the parameter of the federated neural network received from each local client to generate a federated global parameter and transmit the generated federated global parameter to each local client, and
the local client updates the parameter of the federated neural network with the federated global parameter received from the server.

7. The split federated learning system of claim 1, wherein the local client acquires an inference result through the global model of the server or acquires an inference result through the local model depending on whether a network communication state of the local client is stable when an inference event occurs after training of the local model is completed.

8. The split federated learning system of claim 7, wherein the local client determines whether the network communication state is stable by comparing a data transmission amount per unit time of the local client and a data size of an output of the personalized neural network, and
the output of the personalized neural network is an output from the personalized neural network by inputting inference target data into the personalized neural network.

9. A method for split federated learning performed on each local client of a system including a plurality of local clients each including a local model and a server including a global model, the local model including a personalized neural network and a federated neural network, and the federated neural network being provided with the same size and structure of the neural network in each local client, the method comprising:
setting the number of parameters configuring the personalized neural network according to performance of the local client;
performing a split learning process for parameter update of the personalized neural network; and
performing a federated learning process for parameter update of the federated neural network.

10. The method of claim 9, wherein, in the setting of the number of parameters configuring the personalized neural network, the number of parameters configuring the personalized neural network is set based on the number of times of floating point operations per second of the local client and processing time required for the local model.

11. The method of claim 9, wherein the performing of the split learning process includes:
inputting local data into the personalized neural network and transmitting an output of the personalized neural network to the server;
receiving a gradient acquired in a training process of the global model from the server; and
inputting the received gradient into the personalized neural network to update a parameter of the personalized neural network.

12. The method of claim 11, wherein the performing of the federated learning process includes:
updating the parameter of the personalized neural network and a parameter of the federated neural network, respectively, through local data, and transmitting the updated parameter of the federated neural network to the server;
receiving a federated global parameter generated by aggregating the parameter of the federated neural network of each local client from the server; and
updating the parameter of the federated neural network with the received federated global parameter.

13. The method of claim 9, further comprising:
checking whether an inference event occurs after training of the local model is completed;
determining whether a network communication state of the local client is stable when the inference event occurs;
inputting inference target data into the personalized neural network and transmitting an output of the personalized neural network to the server when the network communication state is stable; and
receiving an inference result for the inference target data from the global model of the server.

14. The method of claim 13, wherein, in the determining of whether the network communication state is stable, whether the network communication state is stable is determined by comparing a data transmission amount per unit time of the local client and a data size of an output of the personalized neural network.

15. The method of claim 13, further comprising:
inputting the output of the personalized neural network into the federated neural network to acquire an inference result for the inference target data when the network communication state is not stable.

16. A local client of a split federated learning system that includes a plurality of local clients each including a local model and a server including a global model,
wherein the local model includes a personalized neural network and a federated neural network,
the federated neural network is provided with the same size and structure of the neural network in each local client,
the local client includes a memory in which one or more programs stored, and
the one or more programs include:
an instruction for setting the number of parameters configuring the personalized neural network according to performance of the local client;
an instruction for performing a split learning process for parameter update of the personalized neural network; and
an instruction for performing a federated learning process for parameter update of the federated neural network.
